(19) United States
(12) Patent Application Publication
(10) Pub. No.: US 2015/0232664 A1
(43) Pub. Date: Aug. 20, 2015

(54) THERMALLY CONDUCTIVE BLENDED POLYMER COMPOSITIONS WITH IMPROVED FLAME RETARDANCY

(71) Applicants: Mingcheng Guo, Shanghai (CN); Frans Mercx, Halsteren (NL)

(72) Inventors: Mingcheng Guo, Shanghai (CN); Frans Mercx, Halsteren (NL)

(73) Assignee: SABIC Innovative Plastics IP B.V., Bergen OP Zoom (NL)

(21) Appl. No.: 14/110,334

(22) PCT Filed: Sep. 7, 2012
(86) PCT No.: PCT/CN2012/081117

§ 371 Date: May 8, 2015

(51) Int. Cl. C08L 77/02; C09K 5/14

(52) U.S. Cl. CPC C08L 77/02; C09K 5/14

(57) ABSTRACT

Disclosed herein are methods and compositions of thermally conductive polymers with improved flame retardancy. The resulting compositions can be used in the manufacture of articles while still retaining the advantageous physical properties of thermally conductive polymers with improved flame retardancy. This abstract is intended as a scanning tool for purposes of searching in the particular art and is not intended to be limiting of the present invention.

### FIELD OF INVENTION

The present invention relates to organic polymer compositions having, among other characteristics, improved flame retardancy, and specifically to blended polymer compositions comprising an organic polymer such as a polyamide, a polyester, or a polyolefin; a thermally conductive filler such as magnesium hydroxide or boehmite; and a char-forming polymer such as a polyarylene sulfide; wherein the blended polymer composition has improved flame retardancy without adversely affecting the thermal conductivity of the polymer composition. Also included herein are methods for preparing and/or using the same, as well as articles formed from such polymer compositions.

### BACKGROUND

In electronic applications, there is an increasing need for thermal management. For example, heat build-up can lead to a reduced product lifetime in light emitting diodes, in drivers, and in contact housings and can also lead to reduced efficiency in solar cells. Accordingly, compositions having poor thermal management can yield inferior products.

Since polymers are electrical and thermal insulators, thermally conductive fillers can be added to improve thermal management. However, an unacceptably high content of thermally conductive filler is typically necessary to achieve thermal conductivities suitable for efficient heat transport through a polymer composite. Such high content is especially undesirable in view of conventional thermally conductive filler materials typically being based on relatively expensive ceramics.

Further, for many electronic applications, flame retardancy is also required. When using relatively low-cost flame-retardants, conventional compositions typically employ phosphorus-based flame retardants to achieve this goal. As would be appreciated by those of skill, adding a mineral-based flame retardant to a polymer composition reduces the total amount of thermal conductive fillers that can be included in the composition, thereby limiting the level of thermal conductivity that can be achieved. Thus, there is a need for thermally conductive polymer compositions with improved flame retardancy. This and other needs are satisfied by the disclosed invention.

### SUMMARY OF THE INVENTION

As described in more detail herein, the present invention provides a compositions having improved flame retardancy. For example, in one aspect, the invention relates to a thermally conductive polymer composition comprising: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide.

In a further aspect, the invention relates to a method of improving the flame retardancy of a thermally conductive polymer composition, the method comprising the step of combining: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide.

In a further aspect, the invention relates to an extruded or injection molded article, comprising the product of extrusion molding or injection molding a composition comprising: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 shows a representative diagram of the lay-out for compounding and melt processing.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### A. DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an,” and “the” include plural referents unless the context clearly dictates otherwise. Thus, for example, reference to “a ketone” includes mixtures of two or more ketones.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated, or a value approximately or about the same as the amount or value in question. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C═C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfo-oxo group” as used herein is represented by the formulas —S(O)₂R, —OS(O)₂R, or, —OS(O)₂OR, where R can be hydrogen, an alkyl, alkenyl, alkynyl, aryl, aralkyl, cycloalkyl, halogenated alkyl, or heterocycloalkyl group described above.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. THERMALLY CONDUCTIVE, FLAME-RETARDANT BLENDED POLYMER COMPOSITIONS

As briefly described above, the present disclosure provides blended polymer compositions having improved flame retardancy. In various aspects, the blended polymer compositions of the present invention comprise an organic polymer selected from polyamides, polyesters or polyolefins; a thermally conductive, flame retardant filler such as magnesium hydroxide or boehmite; and a char-forming polymer such as a polyarylene sulfide. It is understood and herein contemplated that the disclosed blended polymer compositions, in one aspect, have improved flame retardancy relative to blends that do not contain the polyarylene sulfide. In one aspect, the blended polymer composition may optionally further comprise a reinforcing filler, such as, for example, glass fibers. In various further aspects, the blended polymer composition further comprises a high thermally conductive filler, such as, for example, graphite. The disclosed polymer compositions, in a further aspect, provide improved flame retardancy characteristics while substantially retaining thermal conductivity compared to blends that do contain the polyarylene sulfide.

Moreover, because the disclosed compositions show improved flame retardancy relative to blended polymer compositions that do not contain the polyarylene sulfide, also disclosed herein are methods of increasing the flame retardancy of blended polymer composition comprising an organic polymer selected from a polyamide, a polyester or a polyolefin; a filler such as magnesium hydroxide or boehmite; and a char-forming polymer such as a polyarylene sulfide, comprising substituting a portion of the organic polymer with the polyarylene sulfide.

In one aspect, the invention relates to blended polymer compositions with improved flame retardancy, the compositions comprising: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide.

In a further aspect, the composition comprises from about 1 wt % to about 30 wt % of a reinforcing filler, for example, glass fiber. In a further aspect, the composition further comprises a high-thermal conductive filler.

In a further aspect, the composition further comprises an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing.

In a further aspect, the composition further comprises about 0.01 wt % to about 0.50 wt % of a first anti-oxidant additive. In a still further aspect, the composition further comprises about 0.10 wt % to about 0.40 wt % of a first anti-oxidant additive. In a yet further aspect, the composition further comprises about 0.15 wt % to about 0.30 wt % of a first anti-oxidant additive. In an even further aspect, the composition further comprises about 0.10 wt % of a first anti-oxidant additive. In a still further aspect, the composition further comprises about 0.15 wt % of a first anti-oxidant additive. In a yet further aspect, the composition further comprises about 0.20 wt % of a first anti-oxidant additive. In an even further aspect, the composition further comprises about 0.25 wt % of a first anti-oxidant additive. In a still further aspect, the composition further comprises about 0.30 wt % of a first anti-oxidant additive. In various aspects, the first anti-oxidant additive is a sterically hindered phenolic antioxidant. In a further aspect, the first anti-oxidant additive is N,N′-hexamethylene bis[3-(3,5-di-t-butyl-4-hydroxyphenyl)propionamide].

In a further aspect, the composition further comprises about 0.01 wt % to about 0.50 wt % of a second anti-oxidant additive. In a still further aspect, the composition further comprises about 0.10 wt % to about 0.40 wt % of a second anti-oxidant additive. In a yet further aspect, the composition further comprises about 0.15 wt % to about 0.30 wt % of a second anti-oxidant additive. In an even further aspect, the composition further comprises about 0.10 wt % of a second anti-oxidant additive. In a still further aspect, the composition further comprises about 0.15 wt % of a second anti-oxidant additive. In a yet further aspect, the composition further comprises about 0.20 wt % of a second anti-oxidant additive. In an even further aspect, the composition further comprises about 0.25 wt % of a second anti-oxidant additive. In a still further aspect, the composition further comprises about 0.30 wt % of a second anti-oxidant additive. In various aspects, the second anti-oxidant additive is a trisarylphosphite anti-oxidant. In a further aspect, the second anti-oxidant additive is tris(2,4-di-tert-butylphenyl)phosphite.

In a further aspect, the composition further comprises a compatibilizing agent. In various aspects, the composition further comprises a compatibilizing agent present in an amount of from about 0.1 wt % to about 5 wt %, for example, about 0.1, 0.3, 0.5, 0.7, 0.9, 1.2, 1.4, 1.6, 1.8, 2, 2.5, 3, 3.5, 4, 4.5, or 5 wt %; or from about 0.5 wt % to about 1.0 wt %, for example, about 0.5, 0.6, 0.7, 0.8, 0.9, or 1 wt %. In other aspects, the composition further comprises a compatibilizing agent present in an amount less than about 0.1 wt % or greater than about 5 wt %, and the present invention is not intended to be limited to any particular compatibilizing agent concentration. In one aspect, when present the composition further comprises a compatibilizing agent present in an amount of about 0.01 weight percent to about 5 wt %, based on the total weight of the composition. In a further aspect, the composition further comprises a compatibilizing agent present in an amount from about 0.1 to about 2 wt %. In a still further aspect, the composition further comprises a compatibilizing agent present in an amount from about 0.1 to about 0.5 wt %. In one aspect, the composition further comprises a compatibilizing agent present in an amount of about 0.25%, and wherein the compatibilizing agent is a styrenic epoxy material, such as, for example, ADR-4368C. In another aspect, the composition further comprises a compatibilizing agent present in an amount of about 0.50%, and wherein the compatibilizing agent is a styrenic epoxy material, such as, for example, ADR-4368C.

In a further aspect, the composition exhibits a V0 compliant flame retardancy. In various further aspects, the composition exhibits a V1 compliant flame retardancy. In still further aspects, the composition exhibits a V2 compliant flame retardancy. In various aspects, it is understood that flame retardancy is determined in accordance with UL-94 guidelines on calibrated equipment on samples conditioned at 23° C. and 50% relative humidity prior to analysis.

In various aspects, the invention relates to blended polymer compositions with improved flame retardancy, the compositions comprising: about 43.1 wt % of a polyamide; about 40 wt % of magnesium hydroxide; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 39.6 wt % of a polyamide; about 47.5 wt % of magnesium hydroxide; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 37.6 wt % of a polyamide; about 47.5 wt % of magnesium hydroxide; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 35.6 wt % of a polyamide; about 47.5 wt % of magnesium hydroxide; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 34.1 wt % of a polyamide; about 49 wt % of magnesium hydroxide; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.1 wt % of a polyamide; about 55 wt % of magnesium hydroxide; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.1 wt % of a polyamide; about 55 wt % of magnesium hydroxide; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 43.1 wt % of a polyamide;

about 40 wt % of magnesium hydroxide; about 10 wt % glass fiber; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 39.6 wt % of a polyamide; about 47.5 wt % of magnesium hydroxide; about 10 wt % glass fiber; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 37.6 wt % of a polyamide; about 47.5 wt % of magnesium hydroxide; about 10 wt % glass fiber; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 35.6 wt % of a polyamide; about 47.5 wt % of magnesium hydroxide; about 10 wt % glass fiber; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 34.1 wt % of a polyamide; about 49 wt % of magnesium hydroxide; about 10 wt % glass fiber; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.1 wt % of a polyamide; about 55 wt % of magnesium hydroxide; about 10 wt % glass fiber; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.1 wt % of a polyamide; about 55 wt % of magnesium hydroxide; about 10 wt % glass fiber; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 34.6 wt % of a polyamide; about 45.1 wt % of magnesium hydroxide; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.6 wt % of a polyamide; about 45.1 wt % of magnesium hydroxide; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.0 wt % of a polyamide; about 45.1 wt % of magnesium hydroxide; and about 8 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.4 wt % of a polyamide; about 45.1 wt % of magnesium hydroxide; and about 8 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.1 wt % of a polyamide; about 45.1 wt % of magnesium hydroxide; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 30.6 wt % of a polyamide; about 52.6 wt % of magnesium hydroxide; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 30.6 wt % of a polyamide; about 52.6 wt % of magnesium hydroxide; and about 6 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 34.6 wt % of a polyamide; about 45.1 wt % of magnesium hydroxide; about 17.5 wt % of a graphite; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 32.6 wt % of a polyamide; about 45.1 wt % of magnesium hydroxide; about 17.5 wt % of a graphite; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.0 wt % of a polyamide; about 45.1 wt % of magnesium hydroxide; about 17.5 wt % of a graphite; and about 8 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.4 wt % of a polyamide; about 45.1 wt % of magnesium hydroxide; about 17.5 wt % of a graphite; about 0.25 wt % of a compatibilizing agent; and about 8 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 28.1 wt % of a polyamide; about 45.1 wt % of magnesium hydroxide; about 17.5 wt % of a graphite; about 0.50 wt % of a compatibilizing agent; and about 2 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 30.6 wt % of a polyamide; about 52.6 wt % of magnesium hydroxide; about 12.0 wt % of a graphite; and about 4 wt % of a polyarylene sulfide; wherein all weight percent values are based on the total weight of the composition; wherein the composition exhibits a flame retardancy greater than that of an otherwise identical composition without the polyarylene sulfide.

In various aspects, the invention relates to blended polymer compositions with improved flame retardancy, the compositions comprising: about 30.6 wt % of a polyamide; about 52.6 wt % of magnesium hydroxide; about 12.0 wt % of a graphite; and about 6 wt % of a polyarylene sulfide; wherein all weight percent values are based on the total weight of the composition; wherein the composition exhibits a flame retardancy greater than that of an otherwise identical composition without the polyarylene sulfide.

### C. CHAR-FORMING POLYMER

In one aspect, the disclosed blended polymer compositions with improved heat resistance of the present invention comprise a char-forming polymer. In one aspect, char-forming polymers can be polyarylene sulfide polymers. In various further aspects, the char-forming polymer is polyphenylene sulfide

In various aspects, the composition comprises a polyarylene sulfide as the char-forming polymer. The term polyarylene sulfide polymer includes polyphenylene sulfide (PPS), polyarylene sulfide ionomers, polyarylene sulfide copolymers, polyarylene sulfide graft copolymers, block copolymers of polyarylene sulfides with alkenyl aromatic compounds or with vinyl aromatic compounds, and combinations comprising at least one of the foregoing polyarylene sulfides. Polyarylene sulfides are known polymers comprising a plurality of structural units of the formula —R—S— wherein R is an aromatic radical such as phenylene, biphenylene, naphthylene, oxydiphenyl, or diphenyl sulfone. Known methods of preparing polyarylene sulfides include those described in U.S. Pat. No. 4,490,522 to Kawabata et al and U.S. Pat. No. 4,837,301 to Glock et al.

In one aspect, the polyarylene sulfide comprises a plurality of structural units of the formula:

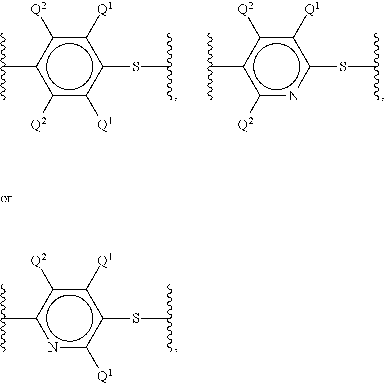

wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms. In a further aspect, each Q¹ is hydrogen, alkyl, or phenyl. In a further aspect, at least one Q¹ is C₁₋₄ alkyl. In a further aspect, each Q² is hydrogen.

In a further aspect, the polyarylene sulfide comprises a plurality of structural units of the formula:

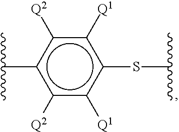

wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms. In a further aspect, each Q¹ is hydrogen, alkyl, or phenyl. In a further aspect, at least one Q¹ is C₁₋₄ alkyl. In a further aspect, each Q² is hydrogen.

PPS is typically prepared by the reaction of p-dichlorobenzene with sodium sulfide, optionally with the use of a minor proportion of 1,3,5-trichlorobenzene as a branching agent. Reference is made, for example, to U.S. Pat. No. 4,794,163, for a disclosure of typical reagents and conditions employed in polyarylene sulfide preparation.

It is often impracticable to determine the molecular weight of a polyarylene sulfide, by reason of its insolubility in essentially all solvents used for molecular weight determination. Indirect characterization of relative molecular weight by melt flow characteristics is commonly employed. The melt flow characteristics of the polyarylene sulfides used according to this invention are not critical; values in the range of 20-1000 g/10 minute (determined at 315° C. under a 5 kg load) are typical.

In various aspects, the polyarylene sulfide is polyphenylene sulfide with a melting temperature of about 270° C. to about 290° C. when determined in accordance with ISO 11357 at 10° C./min and a glass transition temperature of about 80° C. to about 100° C. when determined in accordance with ISO 11357 at 10° C./min. In a still further aspect, the polyarylene sulfide is polyphenylene sulfide with a melting temperature of about 280° C. when determined in accordance with ISO 11357 at 10° C./min and a glass transition temperature of about 90° C. when determined in accordance with ISO 11357 at 10° C./min.

In various further aspects, the polyarylene sulfide is polyphenylene sulfide with a melting temperature of about 270° C. to about 290° C. when determined in accordance with ISO 11357 at 10° C./min; a glass transition temperature of about 80° C. to about 100° C. when determined in accordance with ISO 11357 at 10° C./min; a deflection temperature under load (DTUL) of about 110° C. to about 120° C. under a load of 1.8 MPa when determined in accordance with ISO 75; and a deflection temperature under load (DTUL) of about 90° C. to about 100° C. under a load of 8.0 MPa when determined in accordance with ISO 75. In a still further aspect, the polyarylene sulfide is polyphenylene sulfide with a melting temperature of about 280° C. when determined in accordance with ISO 11357 at 10° C./min; a glass transition temperature of about 90° C. when determined in accordance with ISO 11357 at 10° C./min; a deflection temperature under load (DTUL) of about 115° C. under a load of 1.8 MPa when determined in accordance with ISO 75; and a deflection temperature under load (DTUL) of about 95° C. under a load of 8.0 MPa when determined in accordance with ISO 75.

### D. POLYAMIDES

In one aspect, the disclosed blended polymer compositions with improved heat resistance of the present invention comprise an organic polymer. In one aspect, organic polymers can be polyamide polymers.

Polyamides are generally derived from the polymerization of organic lactams having from 4 to 12 carbon atoms. In various aspects, the polyamides of the present invention are polymerized from lactams of the formula:

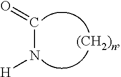

wherein n is about 3 to about 11. In a further aspect, the lactam is epsilon-caprolactam having n equal to 5.

In various further aspects, the polyamide can be synthesized using an α,β-unsaturated gamma-lactone (such as 2(5H-furanone) to effect the regular, sequential alignment of side chains along a polyamide backbone of the formula:

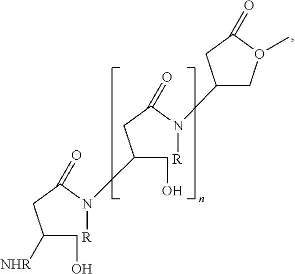

wherein n is about 50 to about 10,000, wherein each R is 1 to about 50 carbon atoms and is optionally substituted with heteroatoms, oxygen, nitrogen, sulfur, or phosphorus and combinations thereof. Depending on the side group (R), the method can produce many different types of polyamides. For instance, when R is a saturated long-chain alkyl group (such as when the amine is tetradecylamine), a polymer having alkyl chains on one side of the polymer backbone and hydroxymethyl groups on the other side of the backbone is formed. When the R group is a polyamine (such as pentaethylenehexamine), a polymer having amino substituted alkyl chains on one side of the polymer backbone and hydroxymethyl groups on the other side of the backbone is formed.

Polyamides of the present invention can also be synthesized from amino acids having about 4 to about 12 carbon atoms. In various aspects, the polyamides of the present invention are polymerized from amino acids of the formula:

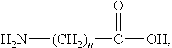

wherein n is about 3 to about 11. In a further aspect, the amino acid is epsilon-aminocaproic acid with n equal to about 5.

Polyamides can also be polymerized from aliphatic dicarboxylic acids having from about 4 to about 12 carbon atoms and aliphatic diamines having from about 2 to about 12 carbon atoms. In various aspects, the polyamides of the present invention are polymerized from aliphatic diamines of the formula:

H₂N—(CH₂)ₙ—NH₂,

wherein n is about 2 to about 12. In a further aspect, the aliphatic diamine is hexamethylenediamine (H₂N(CH₂)₆NH₂). In a still further aspect, the molar ratio of the dicarboxylic acid to the diamine is about 0.66 to about 1.5. In a yet further aspect, the molar ratio is about 0.81 to about 1.22. In an even further aspect, the molar ratio is about 0.96 to about 1.04.

The dicarboxylic acids can be aliphatic dicarboxylic acids, cycloaliphatic dicarboxylic acids, or aromatic dicarboxylic acids. Examples of aliphatic dicarboxylic acids are aliphatic diacids that include carboxylic acids having two carboxyl groups. Suitable examples of cycloaliphatic acids include decahydro naphthalene dicarboxylic acid, norbornene dicarboxylic acids, bicyclo octane dicarboxylic acid, cis-1,4-cyclohexanedicarboxylic acid and trans-1,4-cyclohexanedicarboxylic acids or the like, or a combination comprising at least one of the foregoing acids. In various further aspect, cycloaliphatic diacids are cis-1,4-cyclohexanedicarboxylic acid and trans-1,4-cyclohexanedicarboxylic acids. Examples of linear aliphatic diacids are oxalic acid, malonic acid, pimelic acid, gluteric acid, suberic acid, succinic acid, adipic acid, dimethyl succinic acid, azelaic acid, or the like, or a combination comprising at least one of the foregoing acids. Examples of aromatic dicarboxylic acids are terephthalic acid, phthalic acid, isophthalic acid, naphthalene dicarboxylic acid, or the like, or a combination comprising at least one of the foregoing dicarboxylic acids.

In various aspects, the polyamides of the present invention comprise polypyrrolidone (nylon-4), polycaprolactam (nylon-6), polycapryllactam (nylon-8), polyhexamethylene adipamide (nylon-6,6), polyundecanolactam (nylon-11), polydodecanolactam (nylon-12), polyhexamethylene azelaiamide (nylon-6,9), polyhexamethylene, sebacamide (nylon-6,10), polyhexamethylene isophthalamide (nylon-6,I), polyhexamethylene terephthalamide (nylon-6,T), polyamides of hexamethylene diamine and n-dodecanedioic acid (nylon-6,12), as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2,2-bis-(p-aminocyclohexyl)propane, polyamides resulting from terephthalic acid and 4,4′-diamino-dicyclohexylmethane, and combinations comprising one or more of the foregoing polyamides. The composition may comprise two or more polyamides. For example the polyamide may comprise nylon-6 and nylon-6,6.

Copolymers of the foregoing polyamides are also suitable for use in the practice of the present disclosure. Exemplary polyamide copolymers comprise copolymers of hexamethylene adipamide/caprolactam (nylon-6,6/6), copolymers of caproamide/undecamide (nylon-6/11), copolymers of caproamide/dodecamide (nylon-6/12), copolymers of hexamethylene adipamide/hexamethylene isophthalamide (nylon-6,6/6,I), copolymers of hexamethylene adipamide/hexamethylene terephthalamide (nylon-6,6/6,T), copolymers of hexamethylene adipamide/hexamethylene azelaiamide (nylon-6,6/6,9), and combinations thereof.

Polyamides, as used herein, also comprise the toughened or super tough polyamides. Generally, these super tough nylons are prepared by blending one or more polyamide with one or more polymeric or copolymeric elastomeric toughening agent. Suitable toughening agents can be straight chain or branched as well as graft polymers and copolymers, including core-shell graft copolymers, and are characterized as having incorporated therein either by copolymerization or by grafting on the preformed polymer, a monomer having functional and/or active or highly polar groupings capable of interacting with or adhering to the polyamide matrix so as to enhance the toughness of the polyamide polymer. Super tough polyamides, or super tough nylons, as they are more commonly known, include those available commercially, e.g. from E.I. duPont under the trade name ZYTEL ST, or those prepared in accordance with U.S. Pat. No. 4,174,358 to Epstein; U.S. Pat. No. 4,474,927 to Novak; U.S. Pat. No. 4,346,194 to Roura; and U.S. Pat. No. 4,251,644 to Jeffrion, among others and combinations comprising at least one of the foregoing, can be employed.

### E. POLYOLEFINS

In one aspect, the disclosed blended polymer compositions with improved heat resistance of the present invention comprise an organic polymer. In one aspect, organic polymers can be polyolefin polymers.

Polyolefin, as used herein, refers to a class or group name for thermoplastic polymers derived from simple olefins, including homo or copolymers of olefins. It is to be understood that polyolefins are of the general structure: CₙH₂ₙ and include, but are not limited to, polymers such as, for example, polyethylene, polypropylene and polyisobutylene. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334.

In various aspects, the polyolefin polymer of the present invention is selected from a crystalline polypropylene, crystalline propylene-ethylene block or random copolymer, low density polyethylene, high density polyethylene, linear low density polyethylene, ultra-high molecular weight polyethylene, ethylene-propylene random copolymer, ethylene-propylene-diene copolymer, and the like. Among such polyolefin resins, exemplary embodiments include crystalline polypropylene, crystalline propylene-ethylene copolymer, low-density polyethylene, high-density polyethylene, linear low-density polyethylene, and ultra-high molecular weight polyethylene.

In a further aspect, the polyolefin is selected from polyethylene, high density polyethylene (HDPE), medium density polyethylene (MDPE), and isotactic polypropylene. Polyolefins further include olefin copolymers. Such copolymers include copolymers of ethylene and alpha olefins like 1-octene, propylene and 4-methyl-1-pentene as well as copolymers of ethylene and one or more rubbers and copolymers of propylene and one or more rubbers. Copolymers of ethylene and C3-C10 monoolefins and non-conjugated dienes, herein referred to as EPDM copolymers, are also suitable. Examples of suitable C3-C10 monoolefins for EPDM copolymers include propylene, 1-butene, 2-butene, 1-pentene, 2-pentene, 1-hexene, 2-hexene, 3-hexene, and the like. Suitable dienes include 1,4-hexadiene and monocylic and polycyclic dienes. Mole ratios of ethylene to other C3-C10 monoolefin monomers can range from 95:5 to 5:95 with diene units being present in the amount of from 0.1 to 10 mole percent. EPDM copolymers can be functionalized with an acyl group or electrophilic group for grafting onto the polyphenylene ether as disclosed in U.S. Pat. No. 5,258,455 to Laughner et al. Olefin copolymers further include linear low density polyethylene (LLDPE). Total polyolefin further includes the polyolefin segments of block copolymers, such as the poly(ethylene-butylene) segment of a polystyrene-poly(ethylene-butylene)-polystyrene block copolymer, and the poly(ethylene-propylene) segment of a polystyrene-poly(ethylene-propylene) diblock copolymer.

In a further aspect, the total polyolefin is selected from ethylene-octene copolymers, ethylene-butene copolymers, ethylene-propylene copolymers, polypropylenes, polybutenes, the poly(ethylene-propylene) blocks of polystyrene-poly(ethylene-propylene)-polystyrene triblock copolymers, the poly(ethylene-butylene) blocks of polystyrene-poly(ethylene-butylene)-polystyrene triblock copolymers, and mixtures thereof. In a still further aspect, the polyolefin is selected from polypropylene, polybutene, the poly(ethylene-propylene) blocks of polystyrene-poly(ethylene-propylene)-polystyrene triblock copolymers, the poly(ethylene-butylene) blocks of polystyrene-poly(ethylene-butylene)-polystyrene triblock copolymers, and mixtures thereof.

### F. POLYESTERS

In one aspect, the disclosed blended polymer compositions with improved heat resistance of the present invention comprise an organic polymer. In one aspect, organic polymers can be polyester polymers.

Polyesters are generally polymers in which the backbones are formed by the esterification condensation of polyfunctional alcohols and acids. In various aspects, the blended polymer compositions comprise a polyester polymer, wherein the polyester polymer is a thermoplastic polyester obtained by polymerizing bifunctional carboxylic acid and diol monomer units. Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred from the standpoint of cost. Also, to the extent that the effects of this invention are not lost, other bifunctional carboxylic acids such as aliphatic dicarboxylic acids such as oxalic acid, malonic acid, adipic acid, suberic acid, azelaic acid, sebacic acid, decane dicarboxylic acid, and cyclohexane dicarboxylic acid; and their ester-modified derivatives can also be used.

In one aspect, the polyester of the present invention is a crystalline or amorphous polyesters having repeating structural units represented by the formula:

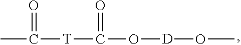

wherein each T is independently a divalent C2-20 aliphatic group, C5-20 cycloaliphatic group, or C6-20 aromatic group derived from a dicarboxylic acid or a chemical equivalent thereof; and each D is independently a divalent C2-20 alkylene group, C6-20 alicyclic group, C6-20 aromatic group, or poly(C2-6 oxyalkylene) group derived from a dihydroxy compound or a chemical equivalent thereof. Copolyesters containing a combination of different T and/or D groups can be used. Chemical equivalents of diacids include the corresponding esters, alkyl esters, e.g., C1-3 dialkyl esters, diaryl esters, anhydrides, salts, acid chlorides, acid bromides, and the like. Chemical equivalents of dihydroxy compounds include the corresponding esters, such as C1-3 dialkyl esters, diaryl esters, and the like. The polyesters can be branched or linear.

In a further aspect, a C6-C20 aromatic carboxylic acid monomer can be used as the dicarboxylic acid. In a still further aspect, the C6-20 aromatic dicarboxylic acid is selected from isophthalic acid, terephthalic acid, 1,2-di(p-carboxyphenyl)ethane, 4,4′-dicarboxydiphenyl ether, 4,4′-bisbenzoic acid, and the like, and 1,4- or 1,5-naphthalene dicarboxylic acids and the like. In various aspects, a combination of isophthalic acid and terephthalic acid can be used, wherein the weight ratio of isophthalic acid to terephthalic acid is 91:9 to 2:98, specifically 25:75 to 2:98.

In a further aspect, a C5-20 cycloaliphatic dicarboxylic acids comprising at least one cycloaliphatic moiety is the dicarboxylic acid monomer used to prepare the polyester of the present invention. In a still further aspect, the C5-20 cycloaliphatic dicarboxylic acid comprise at least one cycloaliphatic moiety and is selected from monocyclo- and bicyclo-aliphatic acids such as decahydronaphthalene dicarboxylic acids, norbornene dicarboxylic acids, bicyclooctane dicarboxylic acids, 1,4-cyclohexanedicarboxylic acid (both cis and trans), specifically trans-1,4-cyclohexanedicarboxylic acid, 1,4-hexylenedicarboxylic acid, and the like. Aliphatic C2-20 dicarboxylic acids such as adipic acid, azelaic acid, dicarboxyl dodecanoic acid, and succinic acid can also be useful.

In a further aspect, the diol monomer used to prepare the polyester can be a straight chain aliphatic and cycloaliphatic diols having 2 to 15 carbon atoms. In a still further aspect, the diol is selected from ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc.; polyethylene glycol; bivalent phenols such as dihydroxydiarylalkanes such as 2,2-bis(4-hydroxylphenyl)propane that can be called bisphenol-A, bis(4-hydroxyphenyl) methane, bis(4-hydroxyphenyl)naphthylmethane, bis(4-hydroxyphenyl)phenylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane, and 2,2-bis(4-hydroxyphenyl)-1,1,1,3,3,3-hexafluoropropane; dihyroxydiarylcycloalkanes such as 1,1-bis(4-hydroxyphenyl)cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′,5,5′-tetramethyl-4,4-diydroxybenzophenone; dihydroxydiaryl sulfides such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides such as bis(4-hydroxyphenyl)sulfoxide; dihydroxydiphenyls such as 4,4′-dihydroxyphenyl; dihydroxyarylfluorenes such as 9,9-bis(4-hydroxyphenyl)fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more kinds of diols can be combined as needed.

In a further aspect, the diol monomer used to prepare the polyester is an aliphatic diol. In a still further aspect, the aliphatic diol is selected from ethylene glycol, 1,2-propylene glycol, 1,3-propylene glycol, 2,2-dimethyl-1,3-propane diol, 2-ethyl-2-methyl-1,3-propane diol, 1,4-butane diol, 1,4-but-2-ene diol, 1,3-1,5-pentane diol, 1,5-pentane diol, dipropylene glycol, 2-methyl-1,5-pentane diol, and the like. In a still further aspect, the diol monomer is a diol comprising a cyloaliphatic moiety. In a yet further aspect, the diol comprising a cyloaliphatic moiety is selected from 1,6-hexane diol, dimethanol decalin, dimethanol bicyclooctane, 1,4-cyclohexane dimethanol (including its cis- and trans-isomers), triethylene glycol, 1,10-decanediol, and the like. Chemical equivalents of the diols include esters, such as C1-3 dialkyl esters, diaryl esters, and the like.

In a further aspect, the polyester of the present invention is selected from polyethylene terephthalate, polybutylene terephthalate, polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters. In a still further aspect, the polyester of the present invention is selected from polyethylene terephthalate (PET) and polybutylene terephthalate (PBT).

In a further aspect, the polyester of the present invention is selected from poly(alkylene terephthalate)polyesters include poly(ethylene terephthalate) (PET), poly(butylene terephthalate) (PBT), poly(ethylene naphthalate) (PEN), poly(butylene naphthalate) (PBN), and poly(1,3-propylene terephthalate) (PPT).

In various further aspects, the polyester of the present invention is selected from poly(1,4-cyclohexylenedimethylene terephthalate) (PCT), poly(1,4-cyclohexylenedimethylene cyclohexane-1,4-dicarboxylate) also known as poly(cyclohexane-14-dimethanol cyclohexane-1,4-dicarboxylate) (PCCD), and poly(1,4-cyclohexylenedimethylene terephthalate-co-isophthalate) (PCTA).

In a further aspect, the polyester of the present invention is a copolyester derived from an aromatic dicarboxylic acid (specifically terephthalic acid and/or isophthalic acid) and a mixture comprising a linear C2-6 aliphatic diol (specifically ethylene glycol and butylene glycol); and a C6-12 cycloaliphatic diol (specifically 1,4-hexane diol, dimethanol decalin, dimethanol bicyclooctane, 1,4-cyclohexane dimethanol and its cis- and trans-isomers, 1,10-decane diol, and the like) or a linear poly(C2-6 oxyalkylene)diol (specifically, poly(oxyethylene)glycol) and poly(oxytetramethylene)glycol). The poly(oxyalkylene)glycol can have a molecular weight of 200 to 10,000 grams per mole, more specifically 400 to 6,000 grams per mole, even more specifically 600 to 2,000 grams per mole, and a carbon to oxygen ratio of 1 to 10, more specifically 1.5 to 6, even more specifically 2.0 to 4.3. The ester units comprising the two or more types of diols can be present in the polymer chain as individual units or as blocks of the same type of units.

In a further aspect, the copolyester is selected from poly(1,4-cyclohexylene dimethylene co-ethylene terephthalate) (PCTG) wherein greater than 50 mol % of the ester groups are derived from 1,4-cyclohexanedimethanol; and poly(ethylene-co-1,4-cyclohexylenedimethylene terephthalate) wherein greater than 50 mol % of the ester groups are derived from ethylene (PTCG). Also included are thermoplastic poly(ester-ether) (TPEE) copolymers such as poly(ethylene-co-poly(oxytetramethylene) terephthalate. Also contemplated for use herein are any of the above polyesters with minor amounts, e.g., from 0.5 to 5 percent by weight, of units derived from aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The polyesters can be obtained by methods well known to those skilled in the art, including, for example, interfacial polymerization, melt-process condensation, solution phase condensation, and transesterification polymerization. Such polyester resins are typically obtained by the condensation or ester interchange polymerization of the diacid or diacid chemical equivalent component with the diol or diol chemical equivalent component with the component. The condensation reaction may be facilitated by the use of a catalyst of the type known in the art, with the choice of catalyst being determined by the nature of the reactants. For example, a dialkyl ester such as dimethyl terephthalate can be transesterified with butylene glycol using acid catalysis, to generate poly(butylene terephthalate). As can be appreciated by one skilled in the art, polyesters can be produced in the presence or absence of common polymerization catalysts represented by titanium, germanium, antimony or the like; and can be produced by interfacial polymerization, melt polymerization or the like.

In various aspects, the polyester polymer of the present invention can be a single kind of thermoplastic polyester used alone, or two or more kinds used in combination. Furthermore, copolyesters can also be used as needed. In a further aspect, a polyester comprising two or more kinds of polyesters in combination is a combination of polybutylene terephthalate and polyethylene terephthalate, or the like.

### G. THERMALLY CONDUCTIVE ADDITIVE

The inventive composition comprises a thermally conductive additive such as a inorganic filler material. In various aspects, the thermally conductive additive can comprise magnesium hydroxide (Mg(OH)₂) or an aluminum oxide hydroxide. In one aspect, the thermally conductive additive comprises magnesium hydroxide. In another aspect, the thermally conductive additive comprises aluminum oxide hydroxide. In various further aspects, the thermally conductive additive is selected from alumina, aluminum oxide, aluminum trihydroxide and magnesium hydroxide.

In a further aspect, the thermally conductive additive has a thermal conductivity of at least about 5.0 W/mK. In a still further aspect, the thermally conductive additive has a thermal conductivity of at least about 6.0 W/mK. In a yet further aspect, the thermally conductive additive has a thermal conductivity of at least about 7.0 W/mK. In an even further aspect, the thermally conductive additive has a thermal conductivity of at least about 8.0 W/mK. In a still further aspect, the thermally conductive additive has a thermal conductivity of at least about 9.0 W/mK. In a yet further aspect, the thermally conductive additive has a thermal conductivity of at least about 10.0 W/mK.

In various further aspects, the thermally conductive additive is selected from alumina, aluminum oxide (Al₂O₃), aluminum trihydroxide, magnesium hydroxide, beryllium oxide, magnesium oxide, zinc oxide, boron nitride, aluminum nitride and silicon carbide.

In a further aspect, the thermally conductive additive is magnesium hydroxide without surface treatment. Suitable forms of magnesium hydroxide are commercially available, and include, for example, MAGNIFIN H5 IV from Martinswerk GmbH (Bergheim, Germany). In a still further aspect, the thermally conductive additive is magnesium hydroxide that has been pre-treated with a vinyl silane. Such silane-treated magnesium hydroxide is commercially available, for example, as MAGNIFIN H5A and MAGNIFIN H5MV from Martinswerk GmbH (Bergheim, Germany).

In a further aspect, the magnesium hydroxide is particulate. The particulate magnesium hydroxide can be a finely divided solid material have a particle size, d₁₀, from about 0.5 to about 1.5 μm. In a still further aspect, the magnesium hydroxide has a particle size, d₁₀, from about 0.6 to about 1.2 μm. In a yet further aspect, the magnesium hydroxide has a particle size, d₁₀, from about 0.7 to about 1.0 μm. In a still further aspect, the magnesium hydroxide has a particle size, d₉₀, from about 2.0 to about 5.0 μm. In a yet further aspect, the magnesium hydroxide has a particle size, d₉₀, from about 2.2 to about 4.8 μm. In an even further aspect, the magnesium hydroxide has a particle size, d₉₀, from about 2.4 to about 4.4 μm.

The concentration of the thermally conductive additive can vary, and the present invention is not intended to be limited to any particular thermally conductive additive concentration. In one aspect, the inventive composition comprises from about 30 wt % to about 70 wt % of thermally conductive additive, for example, about 30, 35, 40, 45, 50, 55, 60 or 70 wt %. In a further aspect, the inventive composition comprises about 35 wt % to about 65 wt % of a thermally conductive additive. In a still further aspect, the inventive composition comprises about 40 wt % to about 60 wt % of a thermally conductive additive. In a yet further aspect, the inventive composition comprises about 45 wt % to about 55 wt % of a thermally conductive additive. In an even further aspect, the inventive composition comprises about 47 wt % to about 57 wt % of a thermally conductive additive. In a still further aspect, the inventive composition comprises about 50 wt % to about 55 wt % of a thermally conductive additive. In a yet further aspect, the inventive composition comprises about 47 wt % to about 55 wt % of a thermally conductive additive.

In various further aspects, the inventive composition comprises about 45.0 wt % of a thermally conductive additive. In a further aspect, the inventive composition comprises about 47.5 wt % of a thermally conductive additive. In a still further aspect, the inventive composition comprises about 50 wt % of a thermally conductive additive. In a yet further aspect, the inventive composition comprises about 52.5 wt % of a thermally conductive additive. In an even further aspect, the inventive composition comprises about 55 wt % of a thermally conductive additive.

In a further aspect, the inventive composition comprises about 45.1 wt % of a thermally conductive additive. In a yet further aspect, the inventive composition comprises about 49 wt % of a thermally conductive additive. In an even further aspect, the inventive composition comprises about 52.6 wt % of a thermally conductive additive.

In a further aspect, the inventive composition comprises about 46 wt % of a thermally conductive additive. In a yet further aspect, the inventive composition comprises about 47 wt % of a thermally conductive additive. In an even further aspect, the inventive composition comprises about 48 wt % of a thermally conductive additive. In a still further aspect, the inventive composition comprises about 49 wt % of a thermally conductive additive. In a yet further aspect, the inventive composition comprises about 50 wt % of a thermally conductive additive. In an even further aspect, the inventive composition comprises about 51 wt % of a thermally conductive additive. In a still further aspect, the inventive composition comprises about 53 wt % of a thermally conductive additive. In a yet further aspect, the inventive composition comprises about 54 wt % of a thermally conductive additive. In an even further aspect, the inventive composition comprises about 56 wt % of a thermally conductive additive. In a still further aspect, the inventive composition comprises about 57 wt % of a thermally conductive additive.

In one aspect, the inventive composition comprises from about 30 wt % to about 70 wt % of Mg(OH)₂, for example, about 30, 35, 40, 45, 50, 55, 60 or 70 wt %. In a further aspect, the inventive composition comprises about 35 wt % to about 65 wt % of Mg(OH)₂. In a still further aspect, the inventive composition comprises about 40 wt % to about 60 wt % of Mg(OH)₂. In a yet further aspect, the inventive composition comprises about 45 wt % to about 55 wt % of Mg(OH)₂. In an even further aspect, the inventive composition comprises about 47 wt % to about 57 wt % of a Mg(OH)₂. In a still further aspect, the inventive composition comprises about 50 wt % to about 55 wt % of Mg(OH)₂. In a yet further aspect, the inventive composition comprises about 47 wt % to about 55 wt % of Mg(OH)₂.

In various further aspects, the inventive composition comprises about 45.0 wt % of Mg(OH)₂. In a further aspect, the inventive composition comprises about 47.5 wt % of Mg(OH)₂. In a still further aspect, the inventive composition comprises about 50 wt % of Mg(OH)₂. In a yet further aspect, the inventive composition comprises about 52.5 wt % of Mg(OH)₂. In an even further aspect, the inventive composition comprises about 55 wt % of Mg(OH)₂.

In a further aspect, the inventive composition comprises about 45.1 wt % of Mg(OH)₂. In a yet further aspect, the inventive composition comprises about 49 wt % of Mg(OH)₂. In an even further aspect, the inventive composition comprises about 52.6 wt % of Mg(OH)₂.

In a further aspect, the inventive composition comprises about 46 wt % of Mg(OH)₂. In a yet further aspect, the inventive composition comprises about 47 wt % of Mg(OH)₂. In an even further aspect, the inventive composition comprises about 48 wt % of Mg(OH)₂. In a still further aspect, the inventive composition comprises about 49 wt % of Mg(OH)₂. In a yet further aspect, the inventive composition comprises about 50 wt % of Mg(OH)₂. In an even further aspect, the inventive composition comprises about 51 wt % of Mg(OH)₂. In a still further aspect, the inventive composition comprises about 53 wt % of Mg(OH)₂. In a yet further aspect, the inventive composition comprises about 54 wt % of Mg(OH)₂. In an even further aspect, the inventive composition comprises about 56 wt % of Mg(OH)₂. In a still further aspect, the inventive composition comprises about 57 wt % of Mg(OH)₂.

In one aspect, the inventive composition comprises from about 30 wt % to about 70 wt % of an aluminum oxide hydroxide, for example, about 30, 35, 40, 45, 50, 55, 60 or 70 wt %. In a further aspect, the inventive composition comprises about 35 wt % to about 65 wt % of an aluminum oxide hydroxide. In a still further aspect, the inventive composition comprises about 40 wt % to about 60 wt % of an aluminum oxide hydroxide. In a yet further aspect, the inventive composition comprises about 45 wt % to about 55 wt % of an aluminum oxide hydroxide. In an even further aspect, the inventive composition comprises about 47 wt % to about 57 wt % of a an aluminum oxide hydroxide. In a still further aspect, the inventive composition comprises about 50 wt % to about 55 wt % of an aluminum oxide hydroxide. In a yet further aspect, the inventive composition comprises about 47 wt % to about 55 wt % of an aluminum oxide hydroxide.

In various further aspects, the inventive composition comprises about 45.0 wt % of an aluminum oxide hydroxide. In a further aspect, the inventive composition comprises about 47.5 wt % of an aluminum oxide hydroxide. In a still further aspect, the inventive composition comprises about 50 wt % of an aluminum oxide hydroxide. In a yet further aspect, the inventive composition comprises about 52.5 wt % of an aluminum oxide hydroxide. In an even further aspect, the inventive composition comprises about 55 wt % of an aluminum oxide hydroxide.

In a further aspect, the inventive composition comprises about 45.1 wt % of an aluminum oxide hydroxide. In a yet further aspect, the inventive composition comprises about 49 wt % of an aluminum oxide hydroxide. In an even further aspect, the inventive composition comprises about 52.6 wt % of an aluminum oxide hydroxide.

In a further aspect, the inventive composition comprises about 46 wt % of an aluminum oxide hydroxide. In a yet further aspect, the inventive composition comprises about 47 wt % of an aluminum oxide hydroxide. In an even further aspect, the inventive composition comprises about 48 wt % of an aluminum oxide hydroxide. In a still further aspect, the inventive composition comprises about 49 wt % of an aluminum oxide hydroxide. In a yet further aspect, the inventive composition comprises about 50 wt % of an aluminum oxide hydroxide. In an even further aspect, the inventive composition comprises about 51 wt % of an aluminum oxide hydroxide. In a still further aspect, the inventive composition comprises about 53 wt % of an aluminum oxide hydroxide. In a yet further aspect, the inventive composition comprises about 54 wt % of an aluminum oxide hydroxide. In an even further aspect, the inventive composition comprises about 56 wt % of an aluminum oxide hydroxide. In a still further aspect, the inventive composition comprises about 57 wt % of an aluminum oxide hydroxide.

In various further aspects, an aluminum oxide hydroxide can be used as the thermally conductive additive. In a still further aspect, the aluminum oxide hydroxide is selected from boehmite, pseudo-boehmite α-aluminum monohydrate, AlO(OH) or α-Al2O3.H2O), and diaspore (β-aluminum monohydrate, AlO(OH) or β-Al2O3.H2O). In a yet further aspect, the aluminum oxide hydroxide is selected from boehmite and pseudo-boehmite. In an even further aspect, the aluminum oxide hydroxide is boehmite. In a still further aspect, the aluminum oxide hydroxide is pseudo-boehmite.

In one aspect, the blended polymer compositions of the present invention further comprise a high thermally conductive additive. In a further aspect, the high thermally conductive additive is graphite. In a still further aspect, the high-thermal conductive filler has a thermal conductivity greater than or equal to about 10 W/mK. In a yet further aspect, the high-thermal conductive filler has a thermal conductivity greater than or equal to about 25 W/mK.

In a further aspect, the high-thermal conductive filler is selected from AlN (aluminum nitride), Al₄C₃ (aluminum carbide), Al₂O₃ (aluminum oxide), BN (Boron nitride), AlON (aluminum oxynitride), MgSiN₂ (magnesium silicon nitride), SiC (silicon carbide), Si₃N₄ (Silicon nitride), graphite, expanded graphite, graphene, and carbon fiber. In a still further aspect, the high-thermal conductive filler is selected from graphite, expanded graphite, graphene, and carbon fiber. In a yet further aspect, the high-thermal conductive filler is a graphite.

In one aspect, the inventive composition further comprises from about 0.1 wt % to about 25 wt % of high thermally conductive additive, for example, about 0.1, 0.25, 0.5, 1, 2, 3, 4, 5, 6, 7, 8, 9, 10, 11, 12, 13, 14, 15, 16, 17, 18, 19, 20, 21, 22, 23, 24, or 25 wt %. In a further aspect, the blended polymer compositions further comprise about 10 wt % to about 25 wt % of a high thermally conductive additive. In an even further aspect, the blended polymer compositions further comprise about 10 wt % to about 20 wt % of a high thermally conductive additive. In a still further aspect, the blended polymer compositions further comprise about 11 wt % to about 19 wt % of a high thermally conductive additive. In a yet further aspect, the blended polymer compositions further comprise about 12 wt % to about 18 wt % of a high thermally conductive additive. In an even further aspect, the blended polymer compositions further comprise about 13 wt % to about 17 wt % of a high thermally conductive additive. In a still further aspect, the blended polymer compositions further comprise about 15 wt % to about 20 wt % of a high thermally conductive additive. In a yet further aspect, the blended polymer compositions further comprise about 16 wt % to about 18 wt % of a high thermally conductive additive.

In a further aspect, the blended polymer compositions further comprise about 10 wt % of a high thermally conductive additive. In a still further aspect, the blended polymer compositions further comprise about 11 wt % of a high thermally conductive additive. In a yet further aspect, the blended polymer compositions further comprise about 12 wt % of a high thermally conductive additive. In an even further aspect, the blended polymer compositions further comprise about 13 wt % of a high thermally conductive additive. In a still further aspect, the blended polymer compositions further comprise about 14 wt % of a high thermally conductive additive. In an even further aspect, the blended polymer compositions further comprise about 15 wt % of a high thermally conductive additive. In a still further aspect, the blended polymer compositions further comprise about 16 wt % of a high thermally conductive additive. In a yet further aspect, the blended polymer compositions further comprise about 17 wt % of a high thermally conductive additive. In a still further aspect, the blended polymer compositions further comprise about 17.5 wt % of a high thermally conductive additive. In an even further aspect, the blended polymer compositions further comprise about 18 wt % of a high thermally conductive additive. In a still further aspect, the blended polymer compositions further comprise about 19 wt % of a high thermally conductive additive. In a yet further aspect, the blended polymer compositions comprise about 20 wt % of a high thermally conductive additive.

In one aspect, the inventive composition further comprises from about 0.1 wt % to about 25 wt % of graphite, for example, about 0.1, 0.25, 0.5, 1, 2, 3, 4, 5, 6, 7, 8, 9, 10, 11, 12, 13, 14, 15, 16, 17, 18, 19, 20, 21, 22, 23, 24, or 25 wt %. Ina further aspect, the blended polymer compositions further comprise about 10 wt % to about 20 wt % of graphite. In a still further aspect, the blended polymer compositions further comprise about 11 wt % to about 19 wt % of graphite. In a yet further aspect, the blended polymer compositions further comprise about 12 wt % to about 18 wt % of graphite. In an even further aspect, the blended polymer compositions further comprise about 13 wt % to about 17 wt % of graphite. In a still further aspect, the blended polymer compositions further comprise about 15 wt % to about 20 wt % of graphite. In a yet further aspect, the blended polymer compositions further comprise about 16 wt % to about 18 wt % of graphite.

In a further aspect, the blended polymer compositions further comprise about 10 wt % of graphite. In a still further aspect, the blended polymer compositions further comprise about 11 wt % of graphite. In a yet further aspect, the blended polymer compositions further comprise about 12 wt % of graphite. In an even further aspect, the blended polymer compositions further comprise about 13 wt % of graphite. In a still further aspect, the blended polymer compositions further comprise about 14 wt % of graphite. In an even further aspect, the blended polymer compositions further comprise about 15 wt % of graphite. In a still further aspect, the blended polymer compositions further comprise about 16 wt % of graphite. In a yet further aspect, the blended polymer compositions further comprise about 17 wt % of graphite. In an even further aspect, the blended polymer compositions further comprise about 18 wt % of graphite. In a still further aspect, the blended polymer compositions further comprise about 19 wt % of graphite. In a yet further aspect, the blended polymer compositions comprise about 20 wt % of graphite.

In various aspects, the graphite is selected from graphitized carbon fiber, natural graphite, synthetic graphite, and spherical graphite particles. The graphite used in the present invention can be synthetically produced or naturally produced, or can be expandable graphite or expanded graphite with a thickness smaller than 1 micron. In one aspect, the graphite is naturally produced. There are three types of naturally produced graphite that are commercially available. They are flake graphite, amorphous graphite and crystal vein graphite. In one aspect, the graphite is flake graphite, wherein the flake graphite is typically found as discrete flakes ranging in size from 10-800 micrometers in diameter and 1-150 micrometers thick and purities ranging from 80-99.9% carbon. In another aspect the graphite is spherical.

In various further aspects, the blended polymer compositions of the present invention further comprise a graphite or carbon black as second thermally conductive additive. In a further aspect, the blended polymer compositions comprise a graphite. In addition, while the compositions of the present invention are described as being further comprising a graphite or a carbon black, it is to be understood that other crystalline or amorphous carbon materials such as vitreous carbon, activated charcoal, activated carbon, carbon fiber or the like may be used in alternative embodiments. The other crystalline or amorphous carbon materials may, in one embodiment, be used in lieu of the carbon black or, in an alternative embodiment, may be used in conjunction with the carbon black and the graphite.

### H. COMPATIBILIZING AGENT

The inventive blended polymer compositions can further comprise a compatibilizing agent to improve the physical properties of the blend, as well as to enable the use of a greater proportion of the organic polymer component, e.g. the polyamide component. When used herein, the expression “compatibilizing agent” refers to those polyfunctional compounds which interact with the char-forming polymer (e.g. a polyarylene sulfide), the organic polymer component (e.g. a polyamide), or, preferably, both. This interaction can be chemical (e.g. grafting) or physical (e.g. affecting the surface characteristics of the dispersed phases). However, in either case the resulting blend exhibits improved compatibility, particularly as evidenced by enhanced impact strength, mold knit line strength and/or elongation. As used herein, the expression “compatibilized blended polymer composition” refers to those compositions which have been physically or chemically compatibilized with an agent as discussed herein.

Suitable compatibilizing agents include, for example, liquid diene polymers, epoxy compounds, oxidized polyolefin wax, quinones, organosilane compounds, polyfunctional compounds, and functionalized polyphenylene ethers obtained by reacting one or more of the previously mentioned compatibilizing agents with polyphenylene ether. The above and other compatibilizing agents are more fully described in U.S. Pat. Nos. 4,315,086; 4,600,741; 4,642,358; 4,826,933; 4,866,14; 4,927,894; 4,980,424; 5,041,504; and 5,115,042. The foregoing compatibilizing agents may be used alone or in various combinations of one another with another. Furthermore, they may be added directly to the melt blend or pre-reacted with either or both the polyphenylene ether and polyamide, as well as with other resinous materials employed in the preparation of the compositions of the present invention.

In a further aspect, the inventive blended polymer composition comprises a compatibilizing agent, such as, for example, a dime acid diglycidyl ester epoxy (DADGE®, available from Aldrich), a 3,4-epoxy cyclohexyl methyl-3,4-epoxy cyclohexane carboxylate (ERL-4221, available from Aldrich), a modified styrene acrylic polymer (ADR-4368C, available from multiple sources, including BASF), or a combination thereof. In other aspects, the inventive polymer composition can comprise a compatibilizing agent not specifically recited herein, provided that such a compatibilizing agent is chemically compatible with the remaining components of the composition and that the compatibilizing agent does not adversely affect the desired properties of the composition. In one aspect, the inventive blended polymer compositions comprise DADGE. In another aspect, the inventive blended polymer compositions comprise ERL-4221. In yet another aspect, the inventive blended polymer compositions comprise ADR-4368C. In another aspect, the inventive blended polymer compositions comprise do not comprise a compatibilizing agent.

In various further aspects, the compatibilizing agent is anepoxy-functional styrene-acrylate oligomer. One such oligomer suitable for use in the present invention is marketed by BASF Corporation as Joncryl™ brand chain extender, e.g. JONCRYL® ADR-4368-C. Additional information about the epoxy functional low molecular weight styrene-acrylate copolymer is disclosed in U.S. Pat. No. 6,605,681 (Villalobos et al.) and U.S. Pat. No. 6,984,694 (Blasius et al), which are incorporated by reference herein.

In various aspects, the oligomeric chain extender is the polymerization product of (i) at least one epoxy-functional (meth)acrylic monomer; and (ii) at least one styrenic and/or (meth)acrylic monomer, wherein the polymerization product has an epoxy equivalent weight of from about 180 to about 2800, a number-average epoxy functionality (Efn) value of less than about 30, a weight-average epoxy functionality (Efw) value of up to about 140, and a number-average molecular weight (Mn) value of less than 6000. In a further aspect, the oligomeric chain extender a polydispersity index of from about 1.5 to about 5.

Various Joncryl™ grades available and useful from BASF are ADR-4300, ADR-4370-S, ADR-4368-F, and ADR-4368-C, which are all solids. Alternatively, one can use liquid grades, namely: ADR-4380, ADR-4385, and ADR-4318. In a further aspect, the oligomeric chain extender is Joncryl™ ADR-4368-C grade. The number average molecular weight of this grade is less than 3000 with approximately 4 epoxy functionalities per polymer chain. In a further aspect, the oligomeric chain extender is an epoxy-functional styrene-acrylate oligomer having a structure represented by a formula:

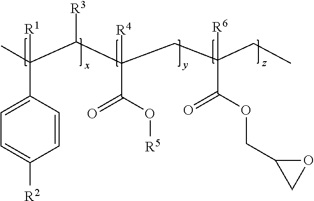

wherein R₁-R₅ can be hydrogen, methyl, a higher alkyl group having from 2 to 10 carbon atoms, or combinations thereof; and Re can be an alkyl group; and wherein x, y, and z each can be between 1 and 20.

A compatibilizing agent, if present, can be present at any concentration that can maintain or improve the properties of the resulting material. The initial amount present will be dependent upon the specific compatibilizing agent chosen and the specific polymeric system to which it is added. In various aspects, the compatibilizing agent can be present in an amount of from about 0.1 wt % to about 5 wt %, for example, about 0.1, 0.3, 0.5, 0.7, 0.9, 1,2, 1.4, 1.6, 1.8, 2, 2.5, 3, 3.5, 4, 4.5, or 5 wt %; or from about 0.5 wt % to about 1.0 wt %, for example, about 0.5, 0.6, 0.7, 0.8, 0.9, or 1 wt %. In other aspects, the compatibilizing agent can be present in an amount less than about 0.1 wt % or greater than about 5 wt %, and the present invention is not intended to be limited to any particular compatibilizing agent concentration. In one aspect, when present, the compatibilizing agent can be present in an amount of about 0.01 weight percent to about 5 wt %, based on the total weight of the composition. In a further aspect, the compatibilizing agent is present in an amount from about 0.1 to about 2 wt %. In a still further aspect, the compatibilizing agent is present in an amount from about 0.1 to about 0.5 wt %. In one aspect, a polymer material comprises about 0.25% of a styrenic epoxy material, such as, for example, ADR-4368C. In another aspect, a polymer material comprises about 0.5 wt % of a styrenic epoxy material, such as, for example, ADR-4368-C.

### I. REINFORCING FILLERS AND FIBERS

In other aspects, the inventive polymer composition can comprise a filler, such as, for example, an inorganic filler. The specific composition of a filler, if present, can vary, provided that the filler is chemically compatible with the remaining components of the polymer composition. In one aspect, the polymer composition comprises a filler, such as, for example, talc. If present, the amount of filler can comprise any amount suitable for a polymer composition that does not adversely affect the desired properties thereof. In one aspect, the inventive polymer comprises about 1 wt % to about 25 wt % of a filler.

In various aspects, the filler is a reinforcing filler. In a further aspect, the reinforcing filler is a reinforcing fiber.

In another aspect, a filler can comprise silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

In one aspect, a filler, if present, can be coated with a layer of metallic material to facilitate conductivity, or surface treated with silanes to improve adhesion and dispersion with the polymeric matrix resin. In addition, the reinforcing fillers can be provided in the form of monofilament or multifilament fibers and can be used individually or in combination with other types of fiber, such as, for example, co-weaving or core/sheath, side-by-side, orange-type or matrix and fibril constructions, or by other methods known to one skilled in the art of fiber manufacture. Exemplary co-woven structures include, for example, glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

In one aspect, the filler is a reinforcing fiber. In a further aspect, the reinforcing fiber comprises glass fiber. Suitable glass fibers include glass fibers having a diameter of 2 to 16 micrometers and an average length, prior to melt mixing with the other components, of 4 to 16 millimeters. The glass fiber can be present in an amount of about 1 wt % to about 25 wt %, based on the total weight of the composition. Within this range the amount of glass fiber can be greater than or equal to about 1 wt %. In a further aspect, the glass fiber is present in an amount greater than or equal to about 5 wt %. Also within this range, the glass fiber can be present in an amount less than or equal to about 20 wt %. In a further aspect, the glass fiber is present in an amount less than or equal to about 17 wt %. In a further aspect, the glass fiber is present in an amount less than or equal to about 15 wt %.

In various further aspects, the glass fiber is present in an amount of about 5 wt % to about 15 wt %. In a still further aspect, the glass fiber is present in an amount of about 7.5 wt % to about 12.5 wt %. In a yet further aspect, the glass fiber is present in an amount of about 5 wt %. In an even further aspect, the glass fiber is present in an amount of about 6 wt %. In a still further aspect, the glass fiber is present in an amount of about 7 wt %. In a yet further aspect, the glass fiber is present in an amount of about 8 wt %. In an even further aspect, the glass fiber is present in an amount of about 9 wt %. In a still further aspect, the glass fiber is present in an amount of about 10 wt %. In a yet further aspect, the glass fiber is present in an amount of about 11 wt %. In an even further aspect, the glass fiber is present in an amount of about 12 wt %. In a still further aspect, the glass fiber is present in an amount of about 13 wt %. In a yet further aspect, the glass fiber is present in an amount of about 14 wt %. In an even further aspect, the glass fiber is present in an amount of about 15 wt %.

### J. OTHER ADDITIVES FOR BLENDED POLYMER COMPOSITIONS

In other aspects, the inventive blended polymer compositions can comprise one or more other materials that can maintain and/or improve various properties of the resulting material. In various aspects, the inventive blended polymer compositions can comprise a lubricant, mold release agent, an anti-oxidant, a processing stabilizer, a melt viscosity modifier, or a combination thereof.

In addition to the thermally conductive additive, the blended polymer composition can include various additives ordinarily incorporated in resin compositions of this type, with the proviso that the additives are selected so as to not significantly adversely affect the desired properties of the thermoplastic composition. Combinations of additives can be used. Such additives can be mixed at a suitable time during the mixing of the components for forming the composition.

In other aspects, a blended polymer composition can comprise one or more of an antioxidant, flame retardant, heat stabilizer, light stabilizer, UV absorbing additive, plasticizer, lubricant, mold release agent, antistatic agent, colorant (e.g., pigment and/or dye), or a combination thereof.

In various aspects, the blended polymer compositions of the present invention comprise one or more antioxidants. Examples of antioxidants useful in the present invention include, but are not limited to, hindered phenols such tetrakis[methylene(3,5-di-t-butyl-4-hydroxyhydrocinnamate)]-methane, 4,4′-thiobis(2-methyl-6-tert-butylphenol), and thiodiethylene bis(3,5-di-tert-butyl-4-hydroxy)hydrocinnamate, octadecyl-3 (3,5-di-tert.butyl-4-hydroxyphenyl)proprionate, pentaerythritol tetrakis(3(3,5-di-tert.butyl-4-hydroxyphenyl)proprionate), phosphites and phosphonites such as tris(2,4-di-tert-butylphenyl)phosphite and thio compounds such as dilaurylthiodipropionate, dimyristylthiodipropionate, and distearylthiodipropionate, potassium iodide, cuprous iodide, various siloxanes, and amines such as polymerized 2,2,4-trimethyl-1,2-dihydroquinoline and the like, or a combination containing at least one of the foregoing.

### K. METHODS FOR MAKING THERMALLY CONDUCTIVE, FLAME-RETARDANT BLENDED POLYMER COMPOSITIONS

In one aspect, the invention relates to a method of improving the flame retardancy of a thermally conductive polymer composition, the method comprising the step of combining: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide. In a further aspect, the polyarylene sulfide is polyphenylene sulfide.

In a further aspect, the method further comprises including from about 1 wt % to about 30 wt % of a reinforcing filler. In a further aspect, the method further comprises including a high-thermal conductive filler. In a further aspect, the method further comprises including an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, the combining step comprises adding the polyarylene sulfide to a mixture of the organic polymer and the magnesium hydroxide or boehmite (γ-AlO(OH)).

In various aspects, the blended polymer compositions of the present invention can be manufactured by various methods. The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the blended polymer compositions of the present invention can be prepared by blending the first polymer, the second polymer, the impact modifier, the flow promoter, the flame retardant, and any polymer composition additive, e.g. a HENSCHEL-Mixer® high speed mixer or other suitable mixer/blender. Other low shear processes, including but not limited to hand mixing, can also accomplish this blending. The mixture can then be fed into the throat of a single or twin screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

In various aspects, the preparation of the blended polymer compositions can be achieved by blending the ingredients under conditions for the formation of an intimate blend. All of the ingredients may be added initially to the processing system, or else certain additives may be precompounded. The blend may be formed by mixing in single or twin screw type extruders or similar mixing devices that can apply a shear to the components, for example Bush co-kneaders, Banbury mixers and Brabender mixers or an injection molding compounding (IMC) process.

In various further aspects, separate extruders are used in the processing of the blend. In a further aspect, the composition is prepared by using a single extruder having multiple feed ports along its length to accommodate the addition of the various components. A vacuum may be applied to the melt through at least one or more vent ports in the extruder to remove volatile impurities in the composition. In a still further aspect, the graphite particles can be feed downstream of the other blend components.

### L. ARTICLES

In one aspect, the invention relates to an extruded or injection molded article, comprising the product of extrusion molding or injection molding a composition comprising: from about 20 wt % to about 60 wt % of an organic polymer selected from polyamide, polyester, and polyolefin; from about 30 wt % to about 70 wt % of a thermal conductive additive selected from magnesium hydroxide or aluminum oxide hydroxide; and from about 1 wt % to about 10 wt % of a polyarylene sulfide; wherein all weight percent values are based on the total weight of the composition; wherein the composition exhibits a flame retardancy greater than that of an otherwise identical composition without the polyarylene sulfide.

In a further aspect, the article further comprises from about 1 wt % to about 30 wt % of a reinforcing filler. In a further aspect, the reinforcing filler is glass fiber. In a further aspect, the article further comprises a high-thermal conductive filler.

In a further aspect, the polyarylene sulfide comprises a plurality of structural units of the formula:

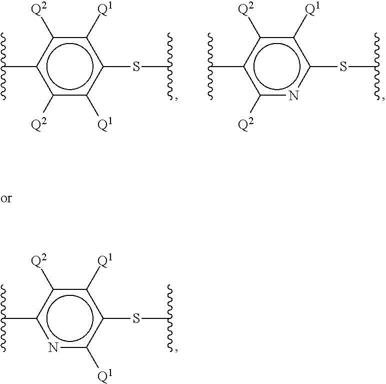

wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms.

In a further aspect, the polyarylene sulfide is polyphenylene sulfide. In a further aspect, the article further comprises an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing. In a further aspect, the composition exhibits a V0 compliant flame retardancy.

In various aspects, the disclosed blended polymer compositions with improved flame resistance of the present invention can be used in making articles. The disclosed blended polymer compositions can be formed into useful shaped articles by a variety of means such as; injection molding, extrusion, rotational molding, compression molding, blow molding, sheet or film extrusion, profile extrusion, gas assist molding, structural foam molding and thermoforming. The blended polymer compositions described herein resins can also be made into film and sheet as well as components of laminate systems. In a further aspect, a method of manufacturing an article comprises melt blending the char-forming polymer, the organic polymer, and the other disclosed components; and molding the extruded composition into an article. In a still further aspect, the extruding is done with a single screw extruder or a twin screw extruder.

In various aspects, the formed articles of the present invention comprise one or more of the following: automotive body panels, computer and business machine housings, hand held electronic device housings, electrical connectors, components of lighting fixtures, ornaments, home appliances, roofs, greenhouses, sun rooms, or swimming pool enclosures, safety door locking systems, heat systems and radiators, shutters, accessories for fences and posts. In a still further aspect, the articles of the present invention are selected from a solar cell, solar cell housing, or an electronic article, e.g. an LED, drive housing, or contact housing. In a yet further aspect, the blended polymer compositions of the present invention can be used in self-controlled heaters, overcurrent protection devices, air conditioning units, automotive applications, such as heated seats, heated mirrors, heated windows, heated steering wheels, and the like, circuit protection devices, perfume dispensers and any other application in which a flame-retardant, thermally conductive polymer blend can be used.

In various further aspects, examples of articles that maybe made using the compositions of the present invention include, but are not limited to, automotive body panels, computer and business machine housings such as housings for monitors, hand held electronic device housings such as housings for cell phones, electrical connectors, and components of lighting fixtures, ornaments, home appliances, roofs, greenhouses, sun rooms, swimming pool enclosures, safety door locking systems, heat systems and radiators, shutters, accessories for fences and posts, and the like.

Formed articles include, for example, computer and business machine housings, home appliances, trays, plates, handles, helmets, automotive parts such as instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present invention comprise exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polymers particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications.

In one aspect, the present invention pertains to articles comprising the disclosed blended polymer compositions. In a further aspect, the article comprising the disclosed blended polymer compositions is used in automotive applications. In a still further aspect, the article used in automotive applications is selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In a yet further aspect, the article used in automotive applications is selected from seats, seat backs, cargo floors, door panels, steering wheels, radio speaker grilles, instrument panel bezels, steering columns, drip rails, energy absorbers, kick panels, mirror housings, grille opening reinforcements, steps, hatch covers, knobs, buttons, and levers. In an even further aspect, the article used in automotive applications is selected from seats, seat backs, cargo floors, door panels, steering wheels, radio speaker grilles, instrument panel bezels, steering columns, drip rails, energy absorbers, kick panels, mirror housings, grille opening reinforcements, steps, hatch covers, knobs, buttons, and levers. In an even further aspect, article is selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, running boards, seats, seat backs, cargo floors, door panels, steering wheels, radio speaker grilles, instrument panel bezels, steering columns, drip rails, energy absorbers, kick panels, mirror housings, grille opening reinforcements, steps, hatch covers, knobs, buttons, and levers.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Flame retardant properties were determined in accordance with UL-94 guidelines on calibrated equipment. Samples were conditioned at 23° C. and 50% relative humidity prior to analysis. For the UL-94 V-0 rating, the maximum total burn time is 50 seconds. In the examples below, a pass rating is indicated if the maximum burn time was 50 seconds or less.

Through-plane and in-plane thermal conductivity were measured on a HotDisk TPS2500 apparatus according to ISO 22007-2 on 100×3 mm discs. A 6 mm radius sensor was used in anisotropic method mode. All measurements were performed under controlled conditions (23° C. and 50% relative humidity). Bulk thermal conductivity was calculated as follows, wherein “thermal conductivity” is indicated by “TC”:

BulkTC=\sqrt{TC_{through-plane}×TCᵢₙ₋ₚₗₐₙₑ}

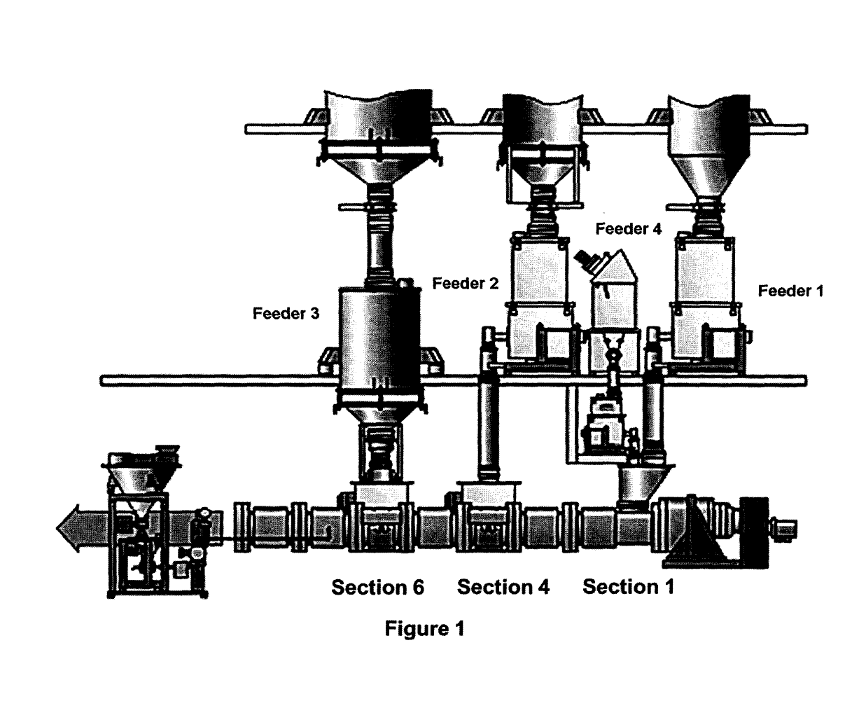

The materials shown in Table 1 were used to prepare the compositions described herein. Melt processing (compounding and extrusion) was carried out using a vacuum vented ZSK 25 (ZSK 25P8,2; Coperion Gmbh, formerly Coperion Werner & Pfleiderer, Stuttgart, Germany) twin-screw extruder having a screw diameter of about 25 mm and L/D of about 40:1. The ZSK 25 was operated with a 4*4(4 holes, each with a 4 mm diameter) die lip and with four independent feeders for different raw materials (feeder 1 & 4 at section 1, feeder 2 at section 4 and feeder 3 at section 6; see FIG. 1 for a diagram showing the layout of the various feeder and sections of the machine) and using the compounding profile conditions as shown in Table 2.

TABLE 1

| Abbre- | | |
|---|---|---|
| viation | Description | Source |
| PA1 | Polyamide 6 produced from caprolactam; | DOMOChemicals |
| | commercially available as Domamid ® 24 | |
| | with an intrinsic viscosity of about 2.4. | |
| PA2 | Polyamide 6 produced from caprolactam; | DOMO |
| | commercially available as Domamid ® 27 | Chemicals |
| | with an intrinsic viscosity of about 2.7. | |
| MG | Mg(OH)₂ with a particle size, d₉₀, of | Albemarle |
| | about 2.40-4.40 μm and a specific | Corporation |
| | surface area of about 4.0-6.0 m²/g; | |
| | commercially available as Magnifin | |
| | H5 IV. | |
| GF | Chopped strand glass fibers comprising | PPG |
| | E-Glass (ASTM D 578-98, paragraph 4.2.2) | |
| | with a nominal fiber diameter of 10 μm | |
| | and a standard cut length of 4.5 mm; | |
| | available as ChopVantage ® HP 3660. | |
| GRPH | Graphite; commercially available as | Asbury Carbons |
| | Graphite 2012, which is a Sri Lankan | |
| | type of natural graphite, with % Carbon | |
| | (LOI) of 97~100, with at least 92 wt % | |
| | of graphite having diameter between 44 | |
| | and 300 micro-meter. | |
| PETS | Pentaerythritol tetrastearate with a maximum | Lonza Benelux |
| | saponification value of about 195 and a | B.V. |
| | maximum hydroxyl number of about 12; | |
| | commercially available as Glycolube P | |
| AO1 | Primary antioxidant; sterically hindered | BASF |
| | phenolic antioxidant, N,N′-hexamethylene | |
| | bis[3-(3,5-di-t-butyl-4 -hydroxy- | |
| | phenyl)propionamide]; commercially | |
| | available as Irganox 1098. | |
| AO2 | Antioxidant; tris(2,4-di-tert-butylphenyl) | BASF |
| | phosphite; commercially available as | |
| | Irgafox 168. | |
| FM | Polymeric chain extender used to increase | BASF |
| | melt viscosity; commercially available as | |
| | Joncryl ® ADR-4386-C, which is flake | |
| | shaped processing additive and can be used | |
| | during processing to increase melt strength. | |
| PPS | Medium viscosity polyphenylene sulfide | Ticona Gmbh |
| | with a glass transition temperature, T_{g}, of | |
| | about 90.0° C. when determined in | |
| | accordance with ISO 11357, and a | |
| | coefficient of thermal expansion (linear, | |
| | parallel to flow) of about53.0 μm/m-° C. | |
| | when determined in accordance with | |
| | ISO 11359; commercially available as | |
| | Fortran ® 0205 B4 | |

TABLE 2

| Description | Unit | Range | Setting |
|---|---|---|---|
| Zone 1 Temp (intake) | ° C. | not adjustable | n.a. |
| Zone 2 Temp | ° C. | 0-380 | 150 |
| Zone 3 Temp | ° C. | 0-380 | 220 |
| Zone 4 Temp | ° C. | 0-380 | 250 |
| Zone 5 Temp | ° C. | 0-380 | 260 |
| Zone 6 Temp | ° C. | 0-380 | 260 |
| Zone 7 Temp | ° C. | 0-380 | 260 |
| Zone 8 Temp | ° C. | 0-380 | 260 |
| Zone 9 Temp | ° C. | 0-380 | 260 |
| Zone 10 Temp | ° C. | 0-380 | 265 |
| Zone 11 Temp (die) | ° C. | 0-380 | 275 |
| Zone 12 Temp | ° C. | n.a. | 255 |
| Die Temp | ° C. | SeeZone 11 | — |
| Screw Speed | rpm | 120-1200 | 300 |
| Torque | %* | — | 60-70 |

*% of maximum torque of the machine; maximum torque is 164 N · m

Test parts were injection molded on an Engel 70T-molding according to the conditions shown in Table3. The pellets were dried for 4 hours at 80° C. in a forced air-circulating oven prior to injection molding. Different molds were used, including UL-bars of different thicknesses and 3 mm thick disks with a diameter of 85 mm.

TABLE 3

| Parameter | Unit | Value |
|---|---|---|
| Drying time | hr | 4 |
| Drying temperature | ° C. | 80 |
| T hopper | ° C. | 40 |
| T zone 1 | ° C. | 270 |
| T zone 2 | ° C. | 280 |
| T zone 3 | ° C. | 290 |
| T nozzle | ° C. | 295 |
| T mold | ° C. | 90 |

The formulations for representative compositions of the present invention (Examples 1-9) are given in Tables 4 and 5, and thermal and flame characteristics are provided in Tables 6 and 7. Comparative Examples, which are labeled as C1-C9, are shown in these same tables.

The data in Table 6 show that when the Mg(OH)₂ content was 40 wt %, flame-out times are relatively long and combined with the observed burning drips a V2 rating is obtained for comparative example C1. Upon addition of PPS flame-out times increases and the flammability rating decreases from V2 to NR (non-rated).

Increasing the Mg(OH)₂ loading to 47.5 wt % still yielded V2 ratings at all tested thicknesses for the comparative sample (C2). Addition of PPS did not improve the flammability rating for thickness of 1.5 mm and lower, in fact ratings dropped from V2 to non-rated, again due to increased flame-out times. However, it was observed that addition of PPS reduced the tendency for dripping at thicknesses of 1.0 mm and above. Moreover, a positive effect upon addition of >4 wt % of PPS resin on flammability rating was observed when sample thickness increased to 2.0 mm, e.g. the data in Table 6 show that the flammability rating improved from NR (example C2) to V1 for 2.0 mm thick samples.

The data clearly show the positive effect of PPS addition at even higher Mg(OH)₂ loadings, e.g. see comparative examples C3, C4 and C5 compared to examples #5 to #9 in Table 6. The addition of PPS leads to greater charring and decreased dripping resulting in an improvement of the UL-94 result at 1.0 mm from V2 (comparative example C3) to V0 for formulations containing 49 wt % Mg(OH)₂ (see example #5). Similar improvements were found at 55 wt % Mg(OH)₂ loading. For example, only V2 ratings were obtained for 1.0 and 0.8 mm thick UL-bars with comparative example C4. In contrast, addition of a small amount of PPS resin (2 wt %, see example #6) improved the rating at 1.0 and 0.8 mm to V1 and effectively prevented dripping. Increasing the PPS loading further yielded a further improvement in the flammability rating to V0. Comparative example C5 and example #9 show that addition of PPS improves the flammability rating for formulations that do not contain glass fiber. For example, addition of 6% of PPS improves flammability rating from V2 to V0 at 2.0, 1.5 and 1.2 mm thickness and from V2 to V1 at 1.0 mm thickness.

It is important to note that the addition of PPS does not significantly affect the bulk thermal conductivity, which is defined as the square root of the product of in-plane and through plane thermal conductivity. Due to changes in viscosity, there are some changes in through and in-plane thermal conductivity, but typically any change in the thermal conductivity in plane is offset by a roughly similar relative but opposite change in the through-plane direction, as a result of which the bulk thermal conductivity remains more or less constant.

The data in Table 7 show that when no PPS resin was present (see comparative examples C6 and C7), the samples showed excessive dripping (10 flaming drips out of 10 bars tested) at 1.5 and 1.2 mm thicknesses. The addition of 2% PPS (see example #10) reduced the number of burning drips by 50%, but the overall rating remained V2. However, a V0 rating was obtained when the PPS content was increased to 4 wt % or higher (see examples #11 and #12).

Oligomeric chain extenders, e.g. Joncryl-ADR-4368-C, are common processing additives in compositions comprising polyamides and polyarylene sulfides. For example, multi-functional epoxy additives of this type can compatibilize the PPS and PA. A small improvement in mechanical properties was observed (data not shown). Without wishing to be bound by a particular theory, the epoxy groups of the compatibilizing agent can react with both the endgroups of the PPS as well as the PA, thus leading to compatibilization. Alternatively, and again without wishing to be bound by a particular theory, chain extension of the PA chains can also occur. Both compatibilization as well as chain extension will have a positive effect on mechanical properties. The comparative example with an oligomeric chain extender, but without PPS (see comparative example C8 in Table 7), showed extensive dripping (burning drips) in the flammability test with a resultant V2 rating at 1.5 and 1.2 mm thickness. However, addition of PPS (see examples #13 and #14 in Table 7) eliminated dripping and resulted in an improved flammability rating of V0.

The data in Table 7 show that the addition of PPS had a positive effect on flammability in formulations comprising both Mg(OH)₂ and graphite (see comparative example C9, example #15 and example #16). The data show that samples comprising PPS had a V0 flammability rating whereas the comparative sample was non-rated. There is a small negative effect observed in bulk thermal conductivity in the samples comprising PPS, Mg(OH)₂, and graphite, but the magnitude is relatively small and less than 10% of the initial value.

TABLE 4

| Component* | C1 | #1 | C2 | #2 | #3 | #4 |
|---|---|---|---|---|---|---|
| PA1 | 49.100 | 43.100 | 41.600 | 39.600 | 37.600 | 35.600 |
| MG | 40.000 | 40.000 | 47.500 | 47.500 | 47.500 | 47.500 |
| GF | 10.000 | 10.000 | 10.000 | 10.000 | 10.000 | 10.000 |
| PETS | 0.500 | 0.500 | 0.500 | 0.500 | 0.500 | 0.500 |
| AO1 | 0.200 | 0.200 | 0.200 | 0.200 | 0.200 | 0.200 |
| AO2 | 0.200 | 0.200 | 0.200 | 0.200 | 0.200 | 0.200 |
| PPS | — | 6.000 | — | 2.000 | 4.000 | — |
| Component* | C3 | #5 | C4 | #6 | #7 | #8 |
| PA1 | 35.600 | 40.100 | 34.100 | 34.100 | 32.100 | 30.100 |
| MG | 47.500 | 49.000 | 49.000 | 55.000 | 55.000 | 55.000 |
| GF | 10.000 | 10.000 | 10.000 | 10.000 | 10.000 | 10.000 |
| PETS | 0.500 | 0.500 | 0.500 | 0.500 | 0.500 | 0.500 |
| AO1 | 0.200 | 0.200 | 0.200 | 0.200 | 0.200 | 0.200 |
| AO2 | 0.200 | 0.200 | 0.200 | 0.200 | 0.200 | 0.200 |
| PPS | 6.000 | — | 6.000 | — | 2.000 | 4.000 |

| Component* | C5 | #9 |
|---|---|---|
| PA1 | 44.100 | 38.100 |
| MG | 55.000 | 55.000 |
| GF | — | — |
| PETS | 0.500 | 0.500 |
| AO1 | 0.200 | 0.200 |
| AO2 | 0.200 | 0.200 |
| PPS | — | 6.000 |

*See TABLE 1 for description of components.

TABLE 5

| Component* | C6 | C7 | #10 | #11 | #12 | C8 |
|---|---|---|---|---|---|---|
| PA1 | 36.60 | — | 34.60 | 32.60 | 28.60 | 36.60 |
| PA2 | — | 36.60 | — | — | — | — |
| MG | 45.10 | 45.10 | 45.10 | 45.10 | 45.10 | 45.10 |
| GRPH | 17.45 | 17.45 | 17.45 | 17.45 | 17.45 | 17.45 |
| PETS | 0.50 | 0.50 | 0.50 | 0.50 | 0.50 | 0.50 |
| AO1 | 0.20 | 0.20 | 0.20 | 0.20 | 0.20 | 0.20 |
| AO2 | 0.15 | 0.15 | 0.15 | 0.15 | 0.15 | 0.15 |
| FM | — | — | — | — | — | — |
| PPS | — | — | 2.00 | 4.00 | 8.00 | — |

| Component* | #13 | #14 | C9 | #15 | #16 |
|---|---|---|---|---|---|
| PA1 | 28.35 | 28.10 | 34.55 | 30.55 | 28.55 |
| PA2 | — | — | — | — | — |
| MG | 45.10 | 45.10 | 52.6 | 52.6 | 52.6 |
| GRPH | 17.45 | 17.45 | 12 | 12 | 12 |
| PETS | 0.50 | 0.50 | 0.5 | 0.5 | 0.5 |
| AO1 | 0.20 | 0.20 | 0.2 | 0.2 | 0.2 |
| AO2 | 0.15 | 0.15 | 0.15 | 0.15 | 0.15 |
| FM | 0.25 | 0.50 | — | — | — |
| PPS | 8.00 | 8.00 | — | 4.00 | 6.00 |

*See TABLE 1 for description of components.

TABLE 6

| Test* | Unit | C1 | #1 | C2 | #2 | #3 | #4 |
|---|---|---|---|---|---|---|---|
| UL-94, 2.0 mm | — | V2 | NR | NR | NR | V1 | V1 |
| UL-94, 1.5 mm | — | V2 | NR | V2 | NR | NR | NR |
| UL-94, 1.2 mm | — | V2 | NR | V2 | NR | NR | NR |
| UL-94, 1.0 mm | — | V2 | NR | V2 | NR | NR | NR |
| UL-94, 0.8 mm | — | V2 | V2 | V2 | NR | NR | NR |
| Thermal | W/mK | 0.72 | 0.76 | 0.89 | 0.93 | 0.73 | 0.66 |
| Conductivity - | | | | | | | |
| Hot disk | | | | | | | |
| through-plan | | | | | | | |
| Thermal | W/mK | 0.83 | 0.78 | 0.96 | 1.00 | 1.25 | 1.32 |
| Conductivity - | | | | | | | |
| Hot disk in- | | | | | | | |
| plan | | | | | | | |
| Thermal | W/mK | 0.77 | 0.77 | 0.92 | 0.96 | 0.96 | 0.93 |
| conductivity - | | | | | | | |
| bulk thermal | | | | | | | |
| conductivity | | | | | | | |
| Test* | Unit | C3 | #5 | C4 | #6 | #7 | #8 |
| UL-94, 2.0 mm | — | n.d. | n.d. | V0 | V0 | V0 | V0 |
| UL-94, 1.5 mm | — | n.d. | n.d. | V0 | V0 | V0 | V0 |
| UL-94, 1.2 mm | — | n.d. | n.d. | V0 | V0 | V0 | V0 |
| UL-94, 1.0 mm | — | V2 | V0 | V2 | V1 | V0 | V0 |
| UL-94, 0.8 mm | — | n.d. | n.d. | V2 | V1 | V0 | V0 |
| Thermal | W/mK | 0.90 | 0.76 | 0.95 | 0.95 | 0.76 | 0.90 |
| Conductivity - | | | | | | | |
| Hot disk | | | | | | | |
| through-plan | | | | | | | |
| Thermal | W/mK | 1.06 | 1.26 | 1.31 | 1.45 | 1.74 | 1.06 |
| Conductivity - | | | | | | | |
| Hot disk in- | | | | | | | |
| plan | | | | | | | |
| Thermal | W/mK | 0.98 | 0.98 | 1.12 | 1.18 | 1.15 | 0.98 |
| conductivity - | | | | | | | |
| bulk thermal | | | | | | | |
| conductivity | | | | | | | |

| Test* | Unit | C5 | #9 |
|---|---|---|---|
| UL-94, 2.0 mm | — | V2 | V0 |
| UL-94, 1.5 mm | — | V2 | V0 |
| UL-94, 1.2 mm | — | V2 | V0 |
| UL-94, 1.0 mm | — | V2 | V1 |
| UL-94, 0.8 mm | — | V2 | V2 |
| Thermal | W/mK | 0.83 | 0.78 |
| Conductivity - | | | |
| Hot disk | | | |
| through-plan | | | |
| Thermal | W/mK | 1.20 | 1.31 |
| Conductivity - | | | |
| Hot disk in- | | | |
| plan | | | |
| Thermal | W/mK | 1.00 | 1.01 |
| conductivity - | | | |
| bulk thermal | | | |
| conductivity | | | |

*Conducted as described herein above; “n.d.” indicates “not determined” and “NR” indicates “non-rated.”

TABLE 7

| Test* | Unit | C6 | C7 | #10 | #11 | #12 | C8 |
|---|---|---|---|---|---|---|---|
| UL-94, 2.0 mm | — | V0 | n.d. | n.d. | n.d. | n.d. | n.d. |
| UL-94, 1.5 mm | — | V2 | V2 | V2 | V0 | V0 | V2 |
| UL-94, 1.2 mm | — | V2 | V2 | V2 | V0 | V0 | V2 |
| UL-94, 1.0 mm | — | n.d. | n.d. | n.d. | n.d. | n.d. | n.d. |
| UL-94, 0.8 mm | — | n.d. | n.d. | n.d. | n.d. | n.d. | n.d. |
| Thermal | W/mK | 1.40 | 1.30 | 1.46 | 1.28 | 1.39 | 1.41 |
| Conductivity - | | | | | | | |
| Hot disk | | | | | | | |
| through-plan | | | | | | | |
| Thermal | W/mK | 3.67 | 4.00 | 3.30 | 3.82 | 3.32 | 3.90 |
| Conductivity - | | | | | | | |
| Hot disk in- | | | | | | | |
| plan | | | | | | | |
| Thermal | W/mK | 2.27 | 2.28 | 2.19 | 2.21 | 2.15 | 2.35 |
| conductivity - | | | | | | | |
| bulk thermal | | | | | | | |
| conductivity | | | | | | | |

| Test* | Unit | #13 | #14 | C9 | #15 | #16 |
|---|---|---|---|---|---|---|
| UL-94, 2.0 mm | — | n.d. | n.d. | n.d. | n.d. | n.d. |
| UL-94, 1.5 mm | — | V0 | V0 | n.d. | n.d. | n.d. |
| UL-94, 1.2 mm | — | V0 | V0 | n.d. | n.d. | n.d. |
| UL-94, 1.0 mm | — | n.d. | n.d. | NR | V0 | V0 |
| UL-94, 0.8 mm | — | n.d. | n.d. | NR | V0 | V0 |
| Thermal | W/mK | 1.35 | 1.36 | 1.32 | 1.30 | 1.21 |
| Conductivity - | | | | | | |
| Hot disk | | | | | | |
| through-plan | | | | | | |
| Thermal | W/mK | 3.31 | 3.64 | 3.30 | 3.18 | 3.51 |
| Conductivity | | | | | | |
| Hot disk in- | | | | | | |
| plan | | | | | | |
| Thermal | W/mK | 2.12 | 2.23 | 2.09 | 2.03 | 2.06 |
| conductivity - | | | | | | |
| bulk thermal | | | | | | |
| conductivity | | | | | | |

*Conducted as described herein above; “n.d.” indicates “not determined” and “NR” indicates “non-rated.”

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A thermally conductive polymer composition comprising:
(a) from about 20 wt % to about 60 wt % of an organic polymer comprising polyamide, polyester, or polyolefin;
(b) from about 30 wt % to about 70 wt % of a thermal conductive additive comprising magnesium hydroxide or aluminum oxide hydroxide; and
(c) from about 1 wt % to about 10 wt % of a polyarylene sulfide;
wherein all weight percent values are based on the total weight of the composition; and
wherein the composition exhibits a flame retardancy greater than that of an otherwise identical composition without the polyarylene sulfide.

2. The composition of claim 1, further comprising from about 1 wt % to about 30 wt % of a reinforcing filler.

3. The composition of claim 2, wherein the reinforcing filler is glass fiber.

4. The composition of claim 1, wherein the thermal conductive additive is magnesium hydroxide.

5. The composition of claim 1, wherein the thermal conductive additive is aluminum oxide hydroxide.

6. The composition of claim 5, wherein the aluminum oxide hydroxide is boehmite (γ-AlO(OH)).

7. (canceled)

8. The composition of claim 1, comprising a high-thermal conductive filler selected from AlN (aluminum nitride), Al₄C₃ (aluminum carbide), Al₂0₃ (aluminum oxide), BN (Boron nitride), AlON (aluminum oxynitride), MgSiN₂ (magnesium silicon nitride), SiC (silicon carbide), Si₃N₄ (Silicon nitride), graphite, expanded graphite, graphene, and carbon fiber.

9. (canceled)

10. (canceled)

11. The composition of claim 8, wherein the high-thermal conductive filler has a thermal conductivity greater than or equal to about 10 W/mK.

12. The composition of claim 8, wherein the high-thermal conductive filler has a thermal conductivity greater than or equal to about 25 W/mK.

13. The composition of claim 8, wherein the high-thermal conductive filler is present in an amount from about 10 wt % to about 25 wt %.

14. The composition of claim 8, wherein the high-thermal conductive filler is present in an amount from about 12 wt % to about 18 wt %.

15. (canceled)

16. (canceled)

17. The composition of claim 1, wherein the polyarylene sulfide comprises a plurality of structural units of the formula: 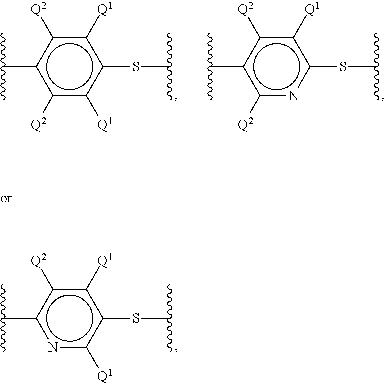
wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms.

18. The composition of claim 17, wherein each Q¹ is hydrogen, alkyl, or phenyl.

19. The composition of claim 17, wherein at least one Q¹ is C₁₋₄ alkyl.

20. The composition of claim 17, wherein each Q² is hydrogen.

21. The composition of claim 1, wherein the polyarylene sulfide comprises a plurality of structural units of the formula: 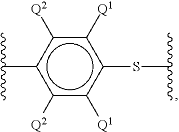
wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms.

22. The composition of claim 21, wherein each Q¹ is hydrogen, alkyl, or phenyl.

23. The composition of claim 21, wherein at least one Q¹ is C₁₋₄ alkyl.

24. The composition of claim 21, wherein each Q² is hydrogen.

25. The composition of claim 1, wherein the polyarylene sulfide is polyphenylene sulfide.

26. The composition of claim 1, further comprising an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing.

27. The composition of claim 1, wherein the composition exhibits a VO compliant flame retardancy.

28. A method of improving the flame retardancy of a thermally conductive polymer composition, the method comprising the step of combining:
(a) from about 20 wt % to about 60 wt % of an organic polymer comprising polyamide, polyester, or polyolefin;
(b) from about 30 wt % to about 70 wt % of a thermal conductive additive comprising magnesium hydroxide or aluminum oxide hydroxide; and
(c) from about 1 wt % to about 10 wt % of a polyarylene sulfide;
wherein all weight percent values are based on the total weight of the composition; and
wherein the composition exhibits a flame retardancy greater than that of an otherwise identical composition without the polyarylene sulfide.

29. The method of claim 28, further comprising including from about 1 wt % to about 30 wt % of a reinforcing filler.

30. (canceled)

31. The method of claim 28, further comprising including an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing.

32. The method of claim 28, wherein the polyarylene sulfide is polyphenylene sulfide.

33. The method of claim 28, wherein the combining step comprises adding the polyarylene sulfide to a mixture of the organic polymer and the magnesium hydroxide or boehmite (γ-AlO(OH)).

34. An extruded or injection molded article, comprising the product of extrusion molding or injection molding a composition comprising:
(a) from about 20 wt % to about 60 wt % of an organic polymer comprising polyamide, polyester, or polyolefin;
(b) from about 30 wt % to about 70 wt % of a thermal conductive additive comprising magnesium hydroxide or aluminum oxide hydroxide; and
(c) from about 1 wt % to about 10 wt % of a polyarylene sulfide;
wherein all weight percent values are based on the total weight of the composition; and
wherein the composition exhibits a flame retardancy greater than that of an otherwise identical composition without the polyarylene sulfide.

35. The article of claim 34, further comprising from about 1 wt % to about 30 wt % of a reinforcing filler.

36. (canceled)

37. The article of claim 34, further comprising a high-thermal conductive filler.

38. The article of claim 34, wherein the polyarylene sulfide comprises a plurality of structural units of the formula: 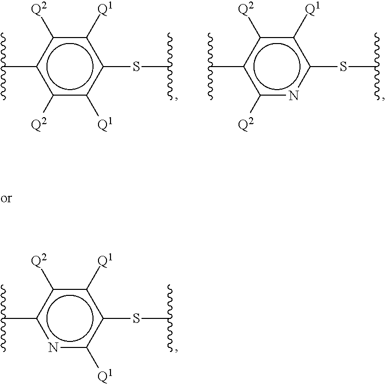
wherein for each structural unit, each Q¹ and each Q² is independently hydrogen, halogen, primary or secondary lower alkyl, phenyl, haloalkyl, aminoalkyl, hydrocarbonoxy, or halohydrocarbonoxy wherein at least two carbon atoms separate the halogen and oxygen atoms.

39. The article of claim 34, wherein the polyarylene sulfide is polyphenylene sulfide.

40. The article of claim 34, further comprising an additive selected from coupling agents, antioxidants, mold release agents, UV absorbers, light stabilizers, heat stabilizers, lubricants, plasticizers, pigments, dyes, colorants, anti-static agents, nucleating agents, anti-drip agents, acid scavengers, and combinations of two or more of the foregoing.

41. The article of claim 34, wherein the composition exhibits a VO compliant flame retardancy.
